(19) United States
(12) Patent Application Publication
(10) Pub. No.: US 2026/0078000 A1
(43) Pub. Date: Mar. 19, 2026

(54) A PROCESS FOR INCREASING THE H2 CONTENT OF SYNGAS

(71) Applicant: BASF SE, Ludwigshafen am Rhein (DE)

(72) Inventors: Elias Christopher FREI, Ludwigshafen am Rhein (DE); Maximilian VICARI, Ludwigshafen am Rhein (DE); Nils BOTTKE, Ludwigshafen am Rhein (DE)

(21) Appl. No.: 19/110,865

(22) PCT Filed: Sep. 15, 2023
(86) PCT No.: PCT/EP2023/075434

§ 371 Date: Mar. 12, 2025

(30) Foreign Application Priority Data
Sep. 16, 2022 (EP) 22196183.2

(51) Int. Cl. C01B 3/34

(52) U.S. Cl. CPC C01B 3/34; C01B 2203/0244; C01B 2203/0255; C01B 2203/061; C01B 2203/062

(57) ABSTRACT

The present invention relates to a process for increasing the H₂ content of syngas, preferably using the hot outlet gas of an autothermal reforming process and/or a process for partial oxidation of hydrocarbons. In particular, it has surprisingly been found that an endothermic NH₃ reforming process can be coupled with a hot outlet gas stemming for example from ATR and/or POx processes to increase the H₂ content of syngas.

### TECHNICAL FIELD

The present invention relates to a process for increasing the H₂ content of syngas, preferably using the hot outlet gas of an autothermal reforming process and/or a process for partial oxidation of hydrocarbons. According to the present invention, a NH₃ stream is fed into a hot outlet gas for initiating a thermally induced NH₃-reforming.

### Introduction

Autothermal reforming (ATR) and partial oxidation of hydrocarbons (POx) processes are commonly used for generating syngas. Said processes are very important for generating syngas with certain H₂:CO:CO₂ molar ratios. Equations (1)-(3) below describe in a simplified manner the processes of importance within a reformer for such processes. In said equations, CH₄ is shown to represent also other possible hydrocarbons. Equation (4) shows the partial oxidation (POx) of CH₄ (again also representative for any other hydrocarbons. The POx can be applied with and without a catalytic material. However, what these reforming processes have in common is the fact, that the outlet gas is very hot (up to 1350° C., due to the exothermic character of the burning with oxygen) and the created syngas is rather lean in hydrogen.

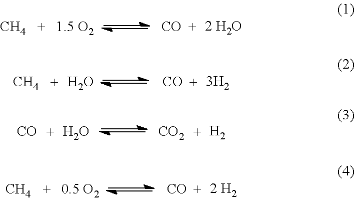

The reforming processes are applied to generate syngas with a certain stoichiometric number R (also designated herein as R-value), wherein R is defined according to the following formula:

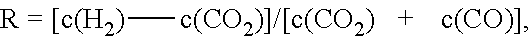

wherein c(H₂), c(CO₂), and c(CO) stand for the molar concentration of H₂, CO₂, and CO in the syngas stream, respectively. Typically, the stoichiometric number R generated by ATR/POx processes is smaller than 2. So, additional hydrogen has to be added for, e.g., the methanol production process where the R-value has to be greater than 2. For example, hydrogen can be added directly, e.g. from the electrolysis of water.

WO 2019/038251 A1 relates to an autothermal ammonia cracking process and discloses a co-feeding of oxygen and ammonia into an ATR reactor for preparing a product gas containing nitrogen and hydrogen. U.S. Pat. No. 8,691,182 B2 and U.S. Pat. No. 8,961,923 B2 relate to the cracking of ammonia and disclose a process wherein gaseous ammonia and oxygen are mixed and burned, preferably at a temperature higher than 1100° C. However, said processes do not relate the preparation of syngas.

As mentioned above, the autothermal reforming processes like POx and ATR of natural gas or hydrocarbons creates basically syngas which is lean in hydrogen. This means additional hydrogen must be added to have syngas in particular suitable for methanol production. The hot outlet gas of the POx/ATR processes is normally used for the steam generation.

### DETAILED DESCRIPTION

Thus, it was an object of the present invention to provide a process for increasing the H₂ content of syngas, especially in a resource-efficient manner.

Surprisingly, it has been found that the high temperature of said outlet gas, for example of ATR and/or POx processes, can function as energy source for endothermic NH₃-reforming. Further, it was surprisingly found that dependent on the temperature of the hot outlet gas no catalytic material, inert material for heat distribution or high temperature stable catalytic material needs to be used therefor. Thus, it has surprisingly been found that an endothermic NH₃ reforming process can be coupled with a hot outlet gas stemming for example from ATR and/or POx processes to increase the H₂ content of syngas, in particular to adjust the stoichiometric number R of the resulting syngas. The resulting syngas having an increased content of H₂ can then be used for specific downstream applications. The underlying reaction equation can be formulated as in equation (5) for the reforming of NH₃ being the crucial step for generating hydrogen.

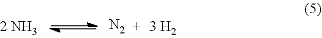

Thus, the present invention facilitates, e.g., a sustainable ATR/POx-based reforming process coupled to a methanol production site, when the NH₃ is produced from regenerative resources and the ATR/POx feedstock is bio-based (renewable feedstock). In view of resource costs, it can be preferred to use NH₃ instead of for example hydrogen from the electrolysis of water. Further, NH₃ is known to store chemically significant amounts of H₂. Therefore, the in-situ creation of H₂ by NH₃-reforming is more cost-efficient and can be applied in a static manner, especially even when the wind or solar for generating H₂ via other processes are off. A further advantage of the present invention is the opportunity to apply it for any feedstock for the autothermal reforming like natural gas or biogas or other hydrocarbons.

The unit bar(abs) refers to an absolute pressure wherein 1 bar equals 10⁵ Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.

Therefore, the present invention relates to a process for increasing the H₂ content of a gas stream comprising H₂ and CO (syngas), the process comprising
(i) providing a first gas stream comprising CO and H₂, and optionally further comprising CO₂, wherein the first gas stream has a temperature in the range of from 750 to 1600° C.;
(ii) providing a second gas stream comprising NH₃;
(iii) contacting the second gas stream provided in (ii) with the first gas stream provided in (i) for converting at least part of the NH₃ to N₂ and H₂.

It is preferred that the first gas stream provided in (i) has a temperature in the range of from 800 to 1600° C., more preferably in the range of from 875 to 1450° C., more preferably in the range of from 900 to 1425° C.

In the case where the first gas stream provided in (i) has a temperature in the range of from 800 to 1600° C., it is preferred according to a first alternative that the first gas stream provided in (i) has a temperature in the range of from 900 to 1200° C., more preferably in the range of from 950 to 1000° C.

In the case where the first gas stream provided in (i) has a temperature in the range of from 800 to 1600° C., it is preferred according to a second alternative that the first gas stream provided in (i) has a temperature in the range of from 1100 to 1500° C., more preferably in the range of from 1325 to 1375° C.

It is preferred that the first gas stream provided in (i) has a molar ratio of H₂ to CO of higher than 0.1:1, more preferably in the range of from 0.1:1 to 10:1, more preferably in the range of from 1.0:1 to 5.0:1, more in the range of from 1.6:1 to 3.4:1.

It is preferred that the first gas stream provided in (i) comprises H₂O, and wherein the first gas stream provided in (i) has a molar ratio of H₂ to H₂O of higher than 0.1:1, more preferably in the range of from 0.1:1 to 250:1, more preferably in the range of from 1.0:1 to 200:1, more in the range of from 1.8:1 to 190:1.

It is preferred that the first gas stream provided in (i) comprises H₂O, and wherein the first gas stream provided in (i) has a molar ratio of CO to H₂O of higher than 0.1:1, more preferably in the range of from 0.1:1 to 150:1, more preferably in the range of from 0.4:1 to 120:1, more in the range of from 0.5:1 to 105:1.

It is preferred that the first gas stream provided in (i) comprises from 35 to 75 volume-%, more preferably from 45 to 65 volume-%, of H₂.

It is preferred that the first gas stream provided in (i) comprises from 5 to 45 volume-%, more preferably from 12 to 36 volume-%, of CO.

It is preferred that the first gas stream provided in (i) comprises H₂O, and wherein the first gas stream provided in (i) comprises from 0.1 to 30 volume-%, more preferably from 0.3 to 25 volume-%, of H₂O.

It is preferred that the first gas stream provided in (i) comprises CO₂, and wherein the first gas stream provided in (i) comprises from 0.1 to 30 volume-%, more preferably from 0.3 to 25 volume-%, of CO₂.

It is preferred that the first gas stream provided in (i) comprises from 0 to 5 volume-%, more preferably from 0 to 4.0 volume-%, more preferably from 0 to 3.3 volume-%, of CH₄.

It is preferred that the first gas stream provided in (i) comprises from 0 to 5 volume-%, more preferably from 0 to 2.5 volume-%, more preferably from 0 to 1.0 volume-%, of N₂.

It is preferred that the first gas stream provided in (i) comprises from 0 to 1 volume-%, more preferably from 0 to 0.5 volume-%, more preferably from 0 to 0.1 volume-%, of Ar.

It is preferred that the first gas stream provided in (i) comprises from 0 to 1 volume-%, more preferably from 0 to 0.5 volume-%, more preferably from 0 to 0.1 volume-%, of O₂, wherein the first precursor gas stream provided in (i) is more preferably free of O₂.

It is preferred that the first gas stream provided in (i) comprises from 0 to 1 volume-% of NH₃, more preferably from 0 to 0.1 volume-%, more preferably from 0 to 0.01 volume-% of NH₃.

It is preferred that the first gas stream provided in (i) comprises CO₂.

It is preferred that the first gas stream provided in (i) has a stoichiometry number R₁ of lower than 2.00, wherein R₁ is defined according to formula (I):

$${R}_{1} = [ {c}_{1} ( {H}_{2} ) - {c}_{1} ( {CO}_{2} ) ] / [ {c}_{1} ( {CO}_{2} ) + {c}_{1} ( CO ) ] , \qquad ( I )$$

wherein c₁(H₂), c₁(CO₂), and c₁(CO) stand for the molar concentration of H₂, CO₂, and CO in the first gas stream, respectively.

It is preferred that the first gas stream provided in (i) comprises a gas stream obtainable or obtained by one or more of a gasification reaction of waste, a gasification reaction of biomass, an autothermal reforming reaction, and a partial oxidation reaction of one or more hydrocarbons, wherein the hydrocarbons are selected from the group consisting of (C₁-C₁₀)alkanes, more preferably (C₁-C₈)alkanes, more preferably (C₁-C₇)alkanes.

It is preferred that providing the first gas stream according to (i) comprises
(i.1) providing a first precursor gas stream comprising CH₄;
(i.2) providing a second precursor gas stream comprising O₂;
(i.3) contacting the second precursor gas stream with the first precursor gas stream, for reacting CH₄ with O₂ to CO, H₂, and optionally H₂O.

In the case where providing the first gas stream according to (i) comprises (i.1), (i.2) and (i.3), it is preferred that the first precursor gas stream provided in (i.1) further comprises H₂, wherein the first precursor gas stream more preferably has molar ratio of CH₄ to H₂ of higher than 20:1, more preferably in the range of from 20:1 to 43:1, more preferably in the range of from 27:1 to 36:1, more in the range of from 30:1 to 33:1.

Further in the case where providing the first gas stream according to (i) comprises (i.1), (i.2) and (i.3), it is preferred that the first precursor gas stream provided in (i.1) further comprises CO₂, wherein the first precursor gas stream provided in (i.1) more preferably has a molar ratio of CH₄ to CO₂ in the range of from 1:1 to 300:1, more preferably in the range of from 2:1 to 275:1, more preferably in the range of from 10:1 to 225:1.

In the case where the first precursor gas stream provided in (i.1) further comprises CO₂, it is preferred according to a first alternative that the first precursor gas stream provided in (i.1) has a molar ratio of CH₄ to CO₂ in the range of from 200:1 to 275:1, more preferably in the range of from 230:1 to 250:1.

In the case where the first precursor gas stream provided in (i.1) further comprises CO₂, it is preferred according to a second alternative that the first precursor gas stream provided in (i.1) has a molar ratio of CH₄ to CO₂ in the range of from 2:1 to 10:1, more preferably in the range of from 2.2:1 to 5.0:1.

Further in the case where providing the first gas stream according to (i) comprises (i.1), (i.2) and (i.3), it is preferred that the first precursor gas stream provided in (i.1) has a molar ratio of H₂ to CO₂ of smaller than 20:1, more preferably in the range of from 0 to 15:1, more preferably in the range of from 0 to 10:1.

Further in the case where providing the first gas stream according to (i) comprises (i.1), (i.2) and (i.3), it is preferred that the first precursor gas stream provided in (i.1) comprises from 40 to 96 volume-%, more preferably from 65 to 95 volume-%, of CH₄.

In the case where the first precursor gas stream provided in (i.1) comprises from 40 to 96 volume-%, it is preferred according to a first alternative that the first precursor gas stream provided in (i.1) comprises from 90 to 95 volume-%, more preferably from 91 to 94 volume-%, of CH₄.

In the case where the first precursor gas stream provided in (i.1) comprises from 40 to 96 volume-%, it is preferred according to a first alternative that the first precursor gas stream provided in (i.1) comprises from 65 to 75 volume-%, more preferably from 68 to 71 volume-%, of CH₄.

Further in the case where providing the first gas stream according to (i) comprises (i.1), (i.2) and (i.3), it is preferred that the first precursor gas stream provided in (i.1) comprises from 0 to 10 volume-%, more preferably from 0 to 3.5 volume-%, more preferably from 0 to 3.1 volume-%, of H₂.

Further in the case where providing the first gas stream according to (i) comprises (i.1), (i.2) and (i.3), it is preferred that the first precursor gas stream provided in (i.1) comprises from 0 to 35 volume-%, more preferably from 0.1 to 32 volume-%, of CO₂.

In the case where the first precursor gas stream provided in (i.1) comprises from 0 to 35 volume-%, it is preferred according to a first alternative that the first precursor gas stream provided in (i.1) comprises from 0.1 to 2.0 volume-%, more preferably from 0.2 to 0.8 volume-%, of CO₂.

In the case where the first precursor gas stream provided in (i.1) comprises from 0 to 35 volume-%, it is preferred according to a second alternative that the first precursor gas stream provided in (i.1) comprises from 20 to 32 volume-%, more preferably from 25 to 31 volume-%, of CO₂.

Further in the case where providing the first gas stream according to (i) comprises (i.1), (i.2) and (i.3), it is preferred that the first precursor gas stream provided in (i.1) comprises from 0 to 5 volume-%, more preferably from 0 to 2.5 volume-%, more preferably from 0 to 2.4 volume-%, of (C₂-C₇)alkanes.

Further in the case where providing the first gas stream according to (i) comprises (i.1), (i.2) and (i.3), it is preferred that the first precursor gas stream provided in (i.1) comprises from 0 to 5 volume-%, more preferably from 0.1 to 2.5 volume-%, more preferably from 0.3 to 2.2 volume-%, of N₂.

Further in the case where providing the first gas stream according to (i) comprises (i.1), (i.2) and (i.3), it is preferred that the first precursor gas stream provided in (i.1) comprises from 0 to 1 volume-%, more preferably from 0 to 0.5 volume-%, more preferably from 0 to 0.1 volume-%, of H₂O, wherein the first precursor gas stream provided in (i.1) is more preferably free of H₂O.

Further in the case where providing the first gas stream according to (i) comprises (i.1), (i.2) and (i.3), it is preferred that from 95 to 100 volume-%, more preferably from 99 to 100 volume-%, more preferably from 99.9 to 100 volume-%, of the second precursor gas stream provided in (i.2) consist of O₂.

Further in the case where providing the first gas stream according to (i) comprises (i.1), (i.2) and (i.3), it is preferred that the second precursor gas stream provided in (i.2) has a volume flow rate in the range of from 1,000 to 10,000 m³/h, more preferably in the range of from 3,800 to 6,900 m³/h, more preferably in the range of from 4,100 to 6,600 m³/h.

Further in the case where providing the first gas stream according to (i) comprises (i.1), (i.2) and (i.3), it is preferred that the second precursor gas stream provided in (i.2) has a mass flow rate in the range of from 3,000 to 12,000 kg/h, more preferably in the range of from 5,500 to 9,800 kg/h, more preferably in the range of from 5,900 to 9,400 kg/h.

Further in the case where providing the first gas stream according to (i) comprises (i.1), (i.2) and (i.3), it is preferred that contacting according to (i.3) is conducted at a pressure in the range of from 1 to 70 bar(abs), more preferably in the range of from 10 to 60 bar(abs), more preferably in the range of from 20 to 50 bar(abs).

It is preferred that the second gas stream provided in (ii) has a different chemical composition than the first gas stream provided in (i).

It is preferred that the second gas stream provided in (ii) has a volume flow rate in the range of from 100 to 10,000 m³/h, more preferably in the range of from 1,100 to 8,700 m³/h, more preferably in the range of from 1,400 to 8,400 m³/h.

It is preferred that the second gas stream provided in (ii) has a mass flow rate in the range of from 100 to 7,000 kg/h, more preferably in the range of from 900 to 6,600 kg/h, more preferably in the range of from 1,100 to 6,400 kg/h.

It is preferred that the second gas stream provided in (ii) has a temperature in the range of from 100 to 500° C., more preferably in the range of from 250 to 350° C., more preferably in the range of from 275 to 325° C.

It is preferred that contacting in (iii) is conducted in a reactor.

It is preferred that contacting the second gas stream with the first gas stream according to (iii) is conducted at a pressure in the range of from 1 to 90 bar(abs), more preferably in the range of from 10 to 80 bar(abs), more preferably in the range of from 20 to 70 bar(abs), more preferably in the range of from 25 to 60 bar(abs).

It is preferred that contacting in (iii) is conducted at a temperature in the range of from 850 to 1400° C., more preferably in the range of from 950 to 1350° C.

In the case where contacting in (iii) is conducted at a temperature in the range of from 850 to 1400° C., it is preferred according to a first alternative that contacting in (iii) is conducted in a reactor, and wherein the reactor comprises an inert material, and wherein contacting in (iii) is more preferably conducted at a temperature in the range of from 850 to 1200° C., more preferably in the range of from 875 to 1100° C., wherein the inert material more preferably comprises one or more of quartz, SiC, alpha alumina, steatite, BN, Si₃N₄, and a ceramic.

In the case where contacting in (iii) is conducted at a temperature in the range of from 850 to 1400° C., it is preferred according to a second alternative that contacting in (iii) is conducted in a reactor, and wherein the reactor comprises a catalytic material, and wherein contacting in (iii) is more preferably conducted at a temperature in the range of from 700 to 925° C., more preferably in the range of from 750 to 900° C.

In the case where the reactor comprises a catalytic material, it is preferred that the catalytic material comprises a metal M1, wherein M1 is Ni, Co, or Ni and Co.

In the case where the catalytic material comprises a metal M1, wherein M1 is Ni, Co, or Ni and Co, it is preferred that the catalytic material further comprises a metal M2 selected from the group consisting of alkali metals, alkaline earth metals, Mo, Fe, Ru, including mixtures of two or more thereof, more preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.

Further in the case where the catalytic material comprises a metal M1, wherein M1 is Ni, Co, or Ni and Co, it is preferred that the catalytic material further comprises one or more support materials onto which the metal M1 or the metals M1 and M2 are supported, wherein the one or more support materials are more preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.

Further in the case where the catalytic material comprises a metal M1, wherein M1 is Ni, Co, or Ni and Co, it is preferred that the catalytic material further comprises a metal M2 as defined herein and that the catalytic material displays an M2:M1 atomic ratio in the range of from 0.1:99.9 to 80:20, more preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

In the case where the catalytic material comprises a metal M2 as defined herein and displays an M2:M1 atomic ratio in the range of from 0.1:99.9 to 80:20, it is preferred that M2 comprises, more preferably is, Fe, and wherein the catalytic material displays an M2:M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.

Further in the case where the catalytic material comprises a metal M2 as defined herein and displays an M2:M1 atomic ratio in the range of from 0.1:99.9 to 80:20, it is preferred that M2 comprises, more preferably is, Ru, and wherein the catalytic material displays an M2:M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.

Further in the case where the catalytic material comprises a metal M1, wherein M1 is Ni, Co, or Ni and Co, it is preferred that the catalytic material further comprises Al and O.

In the case where the catalytic material further comprises Al and O, it is preferred that the catalytic material comprises Ni as the metal M1, wherein more preferably the metal M1 is Ni.

In the case where the catalytic material comprises Ni as the metal M1, it is preferred that the catalytic material further comprises Mg, wherein the Ni:Mg:Al molar ratio is more preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).

Further in the case where the catalytic material comprises Ni as the metal M1, it is preferred according to a first alternative that from 95 to 100 wt.-% of the catalytic material consists of Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case where the catalytic material comprises Ni as the metal M1, it is preferred according to a second alternative that from 95 to 100 wt.-% of the catalytic material consists of M2, Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case where the catalytic material further comprises Al and O, it is preferred that the catalytic material comprises Co as the metal M1, wherein more preferably the metal M1 is Co.

In the case where the catalytic material comprises Co as the metal M1, it is preferred that the catalytic material further comprises La, wherein the Co:La:Al molar ratio is more preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).

Further in the case where the catalytic material comprises Co as the metal M1, it is preferred according to a first alternative that from 95 to 100 wt.-% of the catalytic material consists of Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case where the catalytic material comprises Co as the metal M1, it is preferred according to a second alternative that from 95 to 100 wt.-% of the catalytic material consists of M2, Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that in (iii) from 90 to 100 volume-%, more preferably from 94 to 100 volume-%, more preferably from 96 to 100 volume-%, of NH₃ are converted.

It is preferred that the gas stream obtained in (iii) comprises H₂, CO, and CO₂, wherein the gas stream obtained in (iii) more preferably has a stoichiometry number R_{syngas} of equal to or greater than 2.00, more preferably in the range of from 2.02 to 2.15, more preferably in the range of from 2.04 to 2.06, wherein R_{syngas} is defined according to formula (II):

$${R}_{syngas} = [ {c}_{syngas} ( {H}_{2} ) - {c}_{s y n c a s} ( {CO}_{2} ) ] / [ {c}_{syngas} ( {CO}_{2} ) + {c}_{syngas} ( CO ) ] , \qquad ( II )$$

wherein c_{syngas}(H₂), c_{syngas}(CO₂), and c_{syngas}(CO) stand for the molar concentration of H₂, CO₂, and CO in the gas stream obtained in (iii), respectively.

It is preferred that the gas stream obtained in (iii) has a molar ratio of H₂ and CO in the range of from 0.5:1 to 10.0:1, more preferably in the range of from 1.0:1 to 7.5:1, more preferably in the range of from 1.9:1 to 4.8:1, more preferably in the range of from 2.1:1 to 4.6:1.

It is preferred that the gas stream obtained in (iii) has a molar ratio of H₂ and CO₂ in the range of from 0.5:1 to 40.0:1, more preferably in the range of from 4.9:1 to 36.0:1, more preferably in the range of from 5.4:1 to 35.0:1.

It is preferred that the gas stream obtained in (iii) has a molar ratio of CO and CO₂ in the range of from 0.1:1 to 21.0:1, more preferably in the range of from 0.8:1 to 17.0:1, more preferably in the range of from 1.0:1 to 15.0:1.

It is preferred that the gas stream obtained in (iii) comprises from 50 to 85 volume-%, more preferably from 58 to 80 volume-%, more preferably from 61 to 75 volume-%, of H₂.

It is preferred that the gas stream obtained in (iii) comprises from 0 to 10 volume-%, more preferably from 0 to 5 volume-%, more preferably from 0 to 4.0 volume-%, of CH₄.

It is preferred that the gas stream obtained in (iii) comprises from 0.1 to 20.0 volume-%, more preferably from 1.5 to 12.0 volume-%, more preferably from 1.8 to 11.3 volume-%, of CO₂.

It is preferred that the gas stream obtained in (iii) comprises from 0.1 to 20.0 volume-%, more preferably from 1.8 to 13.0 volume-%, more preferably from 2.3 to 12.1 volume-%, of N₂.

It is preferred that the gas stream obtained in (iii) comprises from 0 to 1 volume-%, more preferably from 0 to 0.5 volume-%, more preferably from 0 to 0.1 volume-%, of H₂O, wherein the first precursor gas stream provided in (i.1) is more preferably free of H₂O.

It is preferred that the process further comprises
(iv) separating residual NH₃ from the gas stream obtained in (iii), for obtaining a purified gas stream.

Further, the present invention relates to a process for the preparation of an alcohol, preferably methanol, employing a gas stream comprising H₂ and CO, and optionally further comprising CO₂, wherein the gas stream is obtained according to any one of the embodiments disclosed herein, wherein the process comprises
(v) using the gas stream obtained in (iii) or the purified gas stream obtained in (iv) as the feed stream.

Yet further, the present invention relates to a process for the preparation of a hydrocarbon, preferably a (C₁₀-C₂₀)alkane, or an ether, preferably dimethylether, employing a gas stream comprising H₂ and CO, and optionally further comprising CO₂, wherein the gas stream is obtained according to any one of the embodiments disclosed herein, wherein the process comprises
(v) using the gas stream obtained in (iii) or the purified gas stream obtained in (iv) as the feed stream.

The unit bar(abs) refers to an absolute pressure wherein 1 bar equals 10⁵ Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for increasing the H₂ content of a gas stream comprising H₂ and CO (syngas), the process comprising
   (i) providing a first gas stream comprising CO and H₂, and optionally further comprising CO₂, wherein the first gas stream has a temperature in the range of from 750 to 1600° C.;
   (ii) providing a second gas stream comprising NH₃;
   (iii) contacting the second gas stream provided in (ii) with the first gas stream provided in (i) for converting at least part of the NH₃ to N₂ and H₂.
2. The process of embodiment 1, wherein the first gas stream provided in (i) has a temperature in the range of from 800 to 1600° C., preferably in the range of from 875 to 1450° C., more preferably in the range of from 900 to 1425° C.
3. The process of embodiment 2, wherein the first gas stream provided in (i) has a temperature in the range of from 900 to 1200° C., preferably in the range of from 950 to 1000° C.
4. The process of embodiment 2, wherein the first gas stream provided in (i) has a temperature in the range of from 1100 to 1500° C., preferably in the range of from 1325 to 1375° C.
5. The process of any one of embodiments 1 to 4, wherein the first gas stream provided in (i) has a molar ratio of H₂ to CO of higher than 0.1:1, preferably in the range of from 0.1:1 to 10:1, more preferably in the range of from 1.0:1 to 5.0:1, more in the range of from 1.6:1 to 3.4:1.
6. The process of any one of embodiments 1 to 5, wherein the first gas stream provided in (i) comprises H₂O, and wherein the first gas stream provided in (i) has a molar ratio of H₂ to H₂O of higher than 0.1:1, preferably in the range of from 0.1:1 to 250:1, more preferably in the range of from 1.0:1 to 200:1, more in the range of from 1.8:1 to 190:1.
7. The process of any one of embodiments 1 to 6, wherein the first gas stream provided in (i) comprises H₂O, and wherein the first gas stream provided in (i) has a molar ratio of CO to H₂O of higher than 0.1:1, preferably in the range of from 0.1:1 to 150:1, more preferably in the range of from 0.4:1 to 120:1, more in the range of from 0.5:1 to 105:1.
8. The process of any one of embodiments 1 to 7, wherein the first gas stream provided in (i) comprises from 35 to 75 volume-%, preferably from 45 to 65 volume-%, of H₂.
9. The process of any one of embodiments 1 to 8, wherein the first gas stream provided in (i) comprises from 5 to 45 volume-%, preferably from 12 to 36 volume-%, of CO.
10. The process of any one of embodiments 1 to 9, wherein the first gas stream provided in (i) comprises H₂O, and wherein the first gas stream provided in (i) comprises from 0.1 to 30 volume-%, preferably from 0.3 to 25 volume-%, of H₂O.
11. The process of any one of embodiments 1 to 10, wherein the first gas stream provided in (i) comprises CO₂, and wherein the first gas stream provided in (i) comprises from 0.1 to 30 volume-%, preferably from 0.3 to 25 volume-%, of CO₂.
12. The process of any one of embodiments 1 to 11, wherein the first gas stream provided in (i) comprises from 0 to 5 volume-%, preferably from 0 to 4.0 volume-%, more preferably from 0 to 3.3 volume-%, of CH₄.
13. The process of any one of embodiments 1 to 12, wherein the first gas stream provided in (i) comprises from 0 to 5 volume-%, preferably from 0 to 2.5 volume-%, more preferably from 0 to 1.0 volume-%, of N₂.
14. The process of any one of embodiments 1 to 13, wherein the first gas stream provided in (i) comprises from 0 to 1 volume-%, preferably from 0 to 0.5 volume-%, more preferably from 0 to 0.1 volume-%, of Ar.
15. The process of any one of embodiments 1 to 14, wherein the first gas stream provided in (i) comprises from 0 to 1 volume-%, preferably from 0 to 0.5 volume-%, more preferably from 0 to 0.1 volume-%, of O₂, wherein the first precursor gas stream provided in (i) is more preferably free of O₂.
16. The process of any one of embodiments 1 to 15, wherein the first gas stream provided in (i) comprises from 0 to 1 volume-% of NH₃, preferably from 0 to 0.1 volume-%, more preferably from 0 to 0.01 volume-% of NH₃.
17. The process of any one of embodiments 1 to 16, wherein the first gas stream provided in (i) comprises CO₂.
18. The process of any one of embodiments 1 to 17, wherein the first gas stream provided in (i) has a stoichiometry number R₁ of lower than 2.00, wherein R₁ is defined according to formula (I):

$${R}_{1} = [ {c}_{1} ( {H}_{2} ) - {c}_{1} ( {CO}_{2} ) ] / [ {c}_{1} ( {CO}_{2} ) + {c}_{1} ( CO ) ] , \qquad ( I )$$

wherein c₁(H₂), c₁(CO₂), and c₁(CO) stand for the molar concentration of H₂, CO₂, and CO in the first gas stream, respectively.
19. The process of any one of embodiments 1 to 18, wherein the first gas stream provided in (i) comprises a gas stream obtainable or obtained by one or more of a gasification reaction of waste, a gasification reaction of biomass, an autothermal reforming reaction, and a partial oxidation reaction of one or more hydrocarbons, wherein the hydrocarbons are selected from the group consisting of (C₁-C₁₀)alkanes, preferably (C₁-C₈)alkanes, more preferably (C₁-C₇)alkanes.
20. The process of any one of embodiments 1 to 19, wherein providing the first gas stream according to (i) comprises
   (i.1) providing a first precursor gas stream comprising CH₄;
   (i.2) providing a second precursor gas stream comprising O₂;
   (i.3) contacting the second precursor gas stream with the first precursor gas stream, for reacting CH₄ with O₂ to CO, H₂, and optionally H₂O.
21. The process of embodiment 20, wherein the first precursor gas stream provided in (i.1) further comprises H₂, wherein the first precursor gas stream preferably has molar ratio of CH₄ to H₂ of higher than 20:1, preferably in the range of from 20:1 to 43:1, more preferably in the range of from 27:1 to 36:1, more in the range of from 30:1 to 33:1.
22. The process of embodiment 20 or 21, wherein the first precursor gas stream provided in (i.1) further comprises CO₂, wherein the first precursor gas stream provided in (i.1) preferably has a molar ratio of CH₄ to CO₂ in the range of from 1:1 to 300:1, preferably in the range of from 2:1 to 275:1, more preferably in the range of from 10:1 to 225:1.
23. The process of embodiment 22, wherein the first precursor gas stream provided in (i.1) has a molar ratio of CH₄ to CO₂ in the range of from 200:1 to 275:1, preferably in the range of from 230:1 to 250:1.
24. The process of embodiment 22, wherein the first precursor gas stream provided in (i.1) has a molar ratio of CH₄ to CO₂ in the range of from 2:1 to 10:1, preferably in the range of from 2.2:1 to 5.0:1.
25. The process of any one of embodiments 20 to 24, wherein the first precursor gas stream provided in (i.1) has a molar ratio of H₂ to CO₂ of smaller than 20:1, preferably in the range of from 0 to 15:1, more preferably in the range of from 0 to 10:1.
26. The process of any one of embodiments 20 to 25, wherein the first precursor gas stream provided in (i.1) comprises from 40 to 96 volume-%, preferably from 65 to 95 volume-%, of CH₄.
27. The process of embodiment 26, wherein the first precursor gas stream provided in (i.1) comprises from 90 to 95 volume-%, preferably from 91 to 94 volume-%, of CH₄.
28. The process of embodiment 26, wherein the first precursor gas stream provided in (i.1) comprises from 65 to 75 volume-%, preferably from 68 to 71 volume-%, of CH₄.
29. The process of any one of embodiments 20 to 28, wherein the first precursor gas stream provided in (i.1) comprises from 0 to 10 volume-%, preferably from 0 to 3.5 volume-%, more preferably from 0 to 3.1 volume-%, of H₂.
30. The process of any one of embodiments 20 to 29, wherein the first precursor gas stream provided in (i.1) comprises from 0 to 35 volume-%, preferably from 0.1 to 32 volume-%, of CO₂.
31. The process of embodiment 30, wherein the first precursor gas stream provided in (i.1) comprises from 0.1 to 2.0 volume-%, preferably from 0.2 to 0.8 volume-%, of CO₂.
32. The process of embodiment 30, wherein the first precursor gas stream provided in (i.1) comprises from 20 to 32 volume-%, preferably from 25 to 31 volume-%, of CO₂.
33. The process of any one of embodiments 20 to 32, wherein the first precursor gas stream provided in (i.1) comprises from 0 to 5 volume-%, preferably from 0 to 2.5 volume-%, more preferably from 0 to 2.4 volume-%, of (C₂-C₇)alkanes.
34. The process of any one of embodiments 20 to 33, wherein the first precursor gas stream provided in (i.1) comprises from 0 to 5 volume-%, preferably from 0.1 to 2.5 volume-%, more preferably from 0.3 to 2.2 volume-%, of N₂.
35. The process of any one of embodiments 20 to 34, wherein the first precursor gas stream provided in (i.1) comprises from 0 to 1 volume-%, preferably from 0 to 0.5 volume-%, more preferably from 0 to 0.1 volume-%, of H₂O, wherein the first precursor gas stream provided in (i.1) is more preferably free of H₂O.
36. The process of any one of embodiments 20 to 35, wherein from 95 to 100 volume-%, preferably from 99 to 100 volume-%, more preferably from 99.9 to 100 volume-%, of the second precursor gas stream provided in (i.2) consist of O₂.
37. The process of any one of embodiments 20 to 36, wherein the second precursor gas stream provided in (i.2) has a volume flow rate in the range of from 1,000 to 10,000 m³/h, preferably in the range of from 3,800 to 6,900 m³/h, more preferably in the range of from 4,100 to 6,600 m³/h.
38. The process of any one of embodiments 20 to 37, wherein the second precursor gas stream provided in (i.2) has a mass flow rate in the range of from 3,000 to 12,000 kg/h, preferably in the range of from 5,500 to 9,800 kg/h, more preferably in the range of from 5,900 to 9,400 kg/h.
39. The process of any one of embodiments 20 to 38, wherein contacting according to (i.3) is conducted at a pressure in the range of from 1 to 70 bar(abs), preferably in the range of from 10 to 60 bar(abs), more preferably in the range of from 20 to 50 bar(abs).
40. The process of any one of embodiments 1 to 39, wherein the second gas stream provided in (ii) has a different chemical composition than the first gas stream provided in (i).
41. The process of any one of embodiments 1 to 40, wherein the second gas stream provided in (ii) has a volume flow rate in the range of from 100 to 10,000 m³/h, preferably in the range of from 1,100 to 8,700 m³/h, more preferably in the range of from 1,400 to 8,400 m³/h.
42. The process of any one of embodiments 1 to 41, wherein the second gas stream provided in (ii) has a mass flow rate in the range of from 100 to 7,000 kg/h, preferably in the range of from 900 to 6,600 kg/h, more preferably in the range of from 1,100 to 6,400 kg/h.
43. The process of any one of embodiments 1 to 42, wherein the second gas stream provided in (ii) has a temperature in the range of from 100 to 500° C., preferably in the range of from 250 to 350° C., more preferably in the range of from 275 to 325° C.
44. The process of any one of embodiments 1 to 43, wherein contacting in (iii) is conducted in a reactor.
45. The process of any one of embodiments 1 to 44, wherein contacting the second gas stream with the first gas stream according to (iii) is conducted at a pressure in the range of from 1 to 90 bar(abs), preferably in the range of from 10 to 80 bar(abs), more preferably in the range of from 20 to 70 bar(abs), more preferably in the range of from 25 to 60 bar(abs).
46. The process of any one of embodiments 1 to 45, wherein contacting in (iii) is conducted at a temperature in the range of from 850 to 1400° C., preferably in the range of from 950 to 1350° C.
47. The process of embodiment 46, wherein contacting in (iii) is conducted in a reactor, and wherein the reactor comprises an inert material, and wherein contacting in (iii) is preferably conducted at a temperature in the range of from 850 to 1200° C., preferably in the range of from 875 to 1100° C., wherein the inert material preferably comprises one or more of quartz, SiC, alpha alumina, steatite, BN, Si₃N₄, and a ceramic.
48. The process of embodiment 46, wherein contacting in (iii) is conducted in a reactor, and wherein the reactor comprises a catalytic material, and wherein contacting in (iii) is preferably conducted at a temperature in the range of from 700 to 925° C., preferably in the range of from 750 to 900° C.
49. The process of embodiment 48, wherein the catalytic material comprises a metal M1, wherein M1 is Ni, Co, or Ni and Co.
50. The process of embodiment 49, wherein the catalytic material further comprises a metal M2 selected from the group consisting of alkali metals, alkaline earth metals, Mo, Fe, Ru, including mixtures of two or more thereof, preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.
51. The process of embodiment 49 or 50, wherein the catalytic material further comprises one or more support materials onto which the metal M1 or the metals M1 and M2 are supported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.
52. The process of any one of embodiments 49 to 51, wherein the catalytic material further comprises a metal M2 as defined in embodiment 50, and wherein the catalytic material displays an M2:M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.
53. The process of embodiment 52, wherein M2 comprises, preferably is, Fe, and wherein the catalytic material displays an M2:M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.
54. The process of embodiment 52 or 53, wherein M2 comprises, preferably is, Ru, and wherein the catalytic material displays an M2:M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.
55. The process of any one of embodiments 49 to 54, wherein the catalytic material further comprises Al and O.
56. The process of embodiment 55, wherein the catalytic material comprises Ni as the metal M1, wherein preferably the metal M1 is Ni.
57. The process of embodiment 56, wherein the catalytic material further comprises Mg, wherein the Ni:Mg:Al molar ratio is preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).
58. The process of embodiment 56 or 57, wherein from 95 to 100 wt.-% of the catalytic material consists of Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
59. The process of embodiment 56 or 57, wherein from 95 to 100 wt.-% of the catalytic material consists of M2, Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
60. The process of embodiment 55, wherein the catalytic material comprises Co as the metal M1, wherein preferably the metal M1 is Co.
61. The process of embodiment 60, wherein the catalytic material further comprises La, wherein the Co:La:Al molar ratio is preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).
62. The process of embodiment 60 or 61, wherein from 95 to 100 wt.-% of the catalytic material consists of Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
63. The process of embodiment 60 or 61, wherein from 95 to 100 wt.-% of the catalytic material consists of M2, Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
64. The process of any one of embodiments 1 to 63, wherein in (iii) from 90 to 100 volume-%, preferably from 94 to 100 volume-%, more preferably from 96 to 100 volume-%, of NH₃ are converted.
65. The process of any one of embodiments 1 to 64, wherein the gas stream obtained in (iii) comprises H₂, CO, and CO₂, wherein the gas stream obtained in (iii) preferably has a stoichiometry number R_{syngas} of equal to or greater than 2.00, more preferably in the range of from 2.02 to 2.15, more preferably in the range of from 2.04 to 2.06, wherein R_{syngas} is defined according to formula (II):

$${R}_{syngas} = [ {c}_{syngas} ( {H}_{2} ) - {c}_{s y n c a s} ( {CO}_{2} ) ] / [ {c}_{syngas} ( {CO}_{2} ) + {c}_{syngas} ( CO ) ] , \qquad ( II )$$

wherein c_{syngas}(H₂), c_{syngas}(CO₂), and c_{syngas}(CO) stand for the molar concentration of H₂, CO₂, and CO in the gas stream obtained in (iii), respectively.
66. The process of any one of embodiments 1 to 65, wherein the gas stream obtained in (iii) has a molar ratio of H₂ and CO in the range of from 0.5:1 to 10.0:1, preferably in the range of from 1.0:1 to 7.5:1, more preferably in the range of from 1.9:1 to 4.8:1, more preferably in the range of from 2.1:1 to 4.6:1.
67. The process of any one of embodiments 1 to 66, wherein the gas stream obtained in (iii) has a molar ratio of H₂ and CO₂ in the range of from 0.5:1 to 40.0:1, preferably in the range of from 4.9:1 to 36.0:1, more preferably in the range of from 5.4:1 to 35.0:1.
68. The process of any one of embodiments 1 to 67, wherein the gas stream obtained in (iii) has a molar ratio of CO and CO₂ in the range of from 0.1:1 to 21.0:1, preferably in the range of from 0.8:1 to 17.0:1, more preferably in the range of from 1.0:1 to 15.0:1.
69. The process of any one of embodiments 1 to 68, wherein the gas stream obtained in (iii) comprises from 50 to 85 volume-%, preferably from 58 to 80 volume-%, more preferably from 61 to 75 volume-%, of H₂.
70. The process of any one of embodiments 1 to 69, wherein the gas stream obtained in (iii) comprises from 0 to 10 volume-%, preferably from 0 to 5 volume-%, more preferably from 0 to 4.0 volume-%, of CH₄.
71. The process of any one of embodiments 1 to 70, wherein the gas stream obtained in (iii) comprises from 0.1 to 20.0 volume-%, preferably from 1.5 to 12.0 volume-%, more preferably from 1.8 to 11.3 volume-%, of CO₂.
72. The process of any one of embodiments 1 to 71, wherein the gas stream obtained in (iii) comprises from 0.1 to 20.0 volume-%, preferably from 1.8 to 13.0 volume-%, more preferably from 2.3 to 12.1 volume-%, of N₂.
73. The process of any one of embodiments 1 to 72, wherein the gas stream obtained in (iii) comprises from 0 to 1 volume-%, preferably from 0 to 0.5 volume-%, more preferably from 0 to 0.1 volume-%, of H₂O, wherein the first precursor gas stream provided in (i.1) is more preferably free of H₂O.
74. The process of any one of embodiments 1 to 73, wherein the process further comprises
   (iv) separating residual NH₃ from the gas stream obtained in (iii), for obtaining a purified gas stream.
75. A process for the preparation of an alcohol, preferably methanol, employing a gas stream comprising H₂ and CO, and optionally further comprising CO₂, wherein the gas stream is obtained according to any one of embodiments 1 to 74, wherein the process comprises
   (v) using the gas stream obtained in (iii) or the purified gas stream obtained in (iv) as the feed stream.
76. A process for the preparation of a hydrocarbon, preferably a (C₁₀-C₂₀)alkane, or an ether, preferably dimethylether, employing a gas stream comprising H₂ and CO, and optionally further comprising CO₂, wherein the gas stream is obtained according to any one of embodiments 1 to 74, wherein the process comprises
   (v) using the gas stream obtained in (iii) or the purified gas stream obtained in (iv) as the feed stream.

The present invention is further illustrated by the following examples and comparative examples.

### EXPERIMENTAL SECTION

The following reference examples, examples and comparative examples were simulated with Aspen Plus software Version 11.

### Reference Example 1: Determination of the Blind Activity of a Reactor in NH₃-Reforming

The blind activity of a reactor was determined for the reference case, where SiC was used as inert material. The NH₃ pressure was set to 30 bar(abs), a H₂O content of 0.5 volume-% was set and the gas hourly space velocity was set to 4000 h⁻¹. The NH₃ conversion was determined at different temperatures as shown in FIG. 1. As can be seen from the results shown in FIG. 1 the NH₃ conversion at a temperature of 650° C. was about 4% for the case where SiC was used as inert material. It can be assumed that at a temperature of 780° C. the NH₃ conversion is about 100%.

### Example 2 and Comparative Example 3: Natural Gas Based Partial Oxidation (POx) Coupled to NH₃ Reforming

The partial oxidation (POx) of natural gas feedstock with 10,000 Nm³/h feed was considered as reference. Table 1 shows the compositions of the inlet streams and the needed amount of oxygen for the POx process. The created syngas was comparatively lean in hydrogen (R-value=1.67). To reach an R-value of 2.05 additional hydrogen was needed. In example 2, a specific amount of NH₃ was added that was needed to deliver the appropriate amount of hydrogen and in comparative example 3 hydrogen was added directly. As can be taken from the data given in table 1, the added NH₃ decomposed in an endothermic reaction, which led to a significant decrease of the outlet temperature from 1350° C. to 1111° C. In this case no catalytic material was needed, since thermally induced decomposition of NH₃ occurred. Table 2 shows the compositions of the final syngas after the addition of NH₃ or hydrogen.

TABLE 1
Natural gas based POx with and without NH₃.

| | | Comparative |
|---|---|---|
| | Example 2 | Example 3 |
| Feedstock (first precursor | 10000 | 10000 |
| gas stream) [Nm³/h] | | |
| Stream composition in parts | | |
| H₂ | 0.02999997 | 0.02999997 |
| CH₄ | 0.93924906 | 0.93924906 |
| CO₂ | 0.00388 | 0.00388 |
| H₂O | 0 | 0 |
| N₂ | 0.003978 | 0.003978 |
| C₂H₆ | 0.01736398 | 0.01736398 |
| C₃H₈ | 0.003395 | 0.003395 |
| n-C₄H₁₀ | 0.001067 | 0.001067 |
| n-C₅H₁₂ | 0.000485 | 0.000485 |
| n-C₆H₁₄ | 0.000582 | 0.000582 |
| n-C₇H₁₆ | 0 | 0 |
| Oxygen feed (second | 6528 | 6528 |
| precursor gas stream) | | |
| [Nm³/h] | | |
| [kg/h] | 9324.18346 | 9324.18346 |
| Feed comprising CO and | | |
| H₂ (first gas stream) | | |
| Stream composition in parts | | |
| CO | 0.308197 | 0.308197 |
| H₂ | 0.57164 | 0.57164 |
| CH₄ | 0.00079 | 0.00079 |
| CO₂ | 0.020866 | 0.020866 |
| N₂ | 0.001314 | 0.001314 |
| O₂ | 1.02 · 10⁻¹³ | 1.02 · 10⁻¹³ |
| Ar | 0.000431 | 0.000431 |
| H₂O | 0.09676 | 0.09676 |
| Ammonia Feed (second | 2506.5504 | 0 |
| gas stream) [Nm³/h] | | |
| [kg/h] | 1904.51804 | 0 |
| T [° C.] | 300 | 0 |
| H₂ feed [Nm³/h] | 0 | 3747.03344 |
| Outlet gasifier | | |
| T [° C.] | 1350 | 1350 |
| p bar(abs) | 32.01 | 32.01 |
| after NH₃ addition | | |
| T [° C.] | 1225.69678 | 1350 |
| after NH₃ conversion | | |
| T[° C.] | 1111.19319 | 1350.03492 |

TABLE 2
Natural gas based POx and the final
syngas compositions after NH₃ removal.

| | | Comparative |
|---|---|---|
| | Example 2 | example 3 |
| Syngas [Nm³/h] | 32433.9691 | 31172.4221 |
| Stream composition in parts | | |
| CO | 0.28756515 | 0.29920215 |
| H₂ | 0.64886973 | 0.67512369 |
| CH₄ | 0.00073703 | 0.00076685 |
| CO₂ | 0.01946278 | 0.02024894 |
| N₂ | 0.03972641 | 0.00126524 |
| O₂ | 9.5095 · 10⁻¹⁴ | 9.8941 · 10⁻¹⁴ |
| Ar | 0.00040253 | 0.00041882 |
| H₂O | 0.00295919 | 0.00295283 |
| NH₃ | 0.00027717 | 2.1484 · 10⁻⁵ |
| Syngas after NH₃ | 32424.9793 | 31171.7524 |
| separation [Nm³/h] | | |
| Stream composition in parts | | |
| CO | 0.28764487 | 0.29920858 |
| H₂ | 0.64904963 | 0.67513819 |
| CH₄ | 0.00073724 | 0.00076687 |
| CO₂ | 0.01946818 | 0.02024937 |
| N₂ | 0.03973743 | 0.00126526 |
| O₂ | 9.5122 · 10⁻¹⁴ | 9.8943 · 10⁻¹⁴ |
| Ar | 0.00040264 | 0.00041882 |
| H₂O | 0.00296001 | 0.0029529 |
| NH₃ | 0 | 0 |
| R-value | 2.04999898 | 2.05000007 |
| Conversion of NH₃ in parts | 0.99641349 | — |

### Example 4 and Comparative Example 5: Biogas Based Partial Oxidation (POx) Coupled to NH₃ Reforming

The partial oxidation (POx) process of a biogas feedstock with 10,000 Nm³/h feed was considered as reference. The biogas comprised a higher CO₂ content than the natural gas used for example 2 and comparative example 3. Therefore, a higher amount of NH₃ had to be fed into the hot outlet of the partial oxidation to reach an R-value of 2.05. Table 3 shows the compositions of the inlet streams and needed oxygen for the POx process. Example 4 shows the biogas conversion and the addition of NH₃. In comparison thereto, hydrogen was added directly in comparative example 5. Since a higher amount of NH₃ was added and converted compared to example 2, the decrease of the outlet temperature was stronger (from 1,350° C. to 671° C.). In this case a catalytic material was needed since at temperatures below 700° C., the thermally induced decomposition was not fast enough. Since the hot outlet was coupled with a catalytic material for the NH₃ reforming, basically an adiabatic process step was included. Table 4 shows the final syngas compositions of the biogas based POx process coupled to the NH₃ reforming.

TABLE 3
Biogas based POx with and without NH₃ addition

| | | Comparative |
|---|---|---|
| | Example 4 | example 5 |
| Feedstock (first precursor | 10000 | 10000 |
| gas stream) [Nm³/h] | | |
| Stream composition in parts | | |
| H₂ | 0 | 0 |
| CH₄ | 0.69207126 | 0.69207126 |
| CO₂ | 0.28709106 | 0.28709106 |
| H₂O | 0 | 0 |
| N₂ | 0.02083767 | 0.02083767 |
| C₂H₆ | 0 | 0 |
| C₃H₈ | 0 | 0 |
| n-C₄H₁₀ | 0 | 0 |
| n-C₅H₁₂ | 0 | 0 |
| n-C₆H₁₄ | 0 | 0 |
| n-C₇H₁₆ | 0 | 0 |
| Oxygen feed (second | 5041.61463 | 5041.6366 |
| precursor gas stream) | | |
| [Nm³/h] | | |
| [kg/h] | 7201.12435 | 7201.15574 |
| Stream comprising CO and | | |
| H₂ (first gas stream) | | |
| Stream composition in parts | | |
| CO | 0.340081 | 0.340081 |
| H₂ | 0.630737 | 0.630737 |
| CH₄ | 0.000872 | 0.000872 |
| CO₂ | 0.023015 | 0.023015 |
| N₂ | 0.001438 | 0.001438 |
| O₂ | 1.12 · 10⁻¹³ | 1.12 · 10⁻¹³ |
| Ar | 0.000476 | 0.000476 |
| H₂O | 0.003356 | 0.003356 |
| Ammonia feed (second | 8307.65976 | 0 |
| gas stream) [Nm³/h] | | |
| [kg/h] | 6312.29591 | 0 |
| T [° C.] | 300 | 0 |
| H₂ feed [Nm³/h] | 0 | 12245.2191 |
| Outlet gasifier | | |
| T [° C.] | 1350.04257 | 1349.96675 |
| p bar(abs) | 32.01 | 32.01 |
| after NH₃ addition | | |
| T [° C.] | 999.959668 | 1349.96675 |
| after NH₃ addition | | |
| T[° C.] | 670.761136 | 1350.09436 |

TABLE 4
Biogas based POx and the corresponding
syngas compositions after NH₃ removal

| | | Comparative |
|---|---|---|
| | Example 4 | example 5 |
| Syngas [Nm³/h] | 36049.4841 | 31811.2078 |
| Stream composition in parts | | |
| CO | 0.22588422 | 0.25597415 |
| H₂ | 0.60455 | 0.68238811 |
| CH₄ | 9.0332 · 10⁻⁵ | 0.00010246 |
| CO₂ | 0.04562006 | 0.05168464 |
| N₂ | 0.11901066 | 0.00653795 |
| O₂ | 6.1139 · 10⁻¹³ | 6.915 · 10⁻¹³ |
| Ar | 0.0002797 | 0.00031694 |
| H₂O | 0.00299062 | 0.00297149 |
| NH₃ | 0.00392024 | 2.4257 · 10⁻⁵ |
| Syngas after NH₃ | 35908.1613 | 31810.4362 |
| separation [Nm³/h] | | |
| Stream composition in parts | | |
| CO | 0.22677323 | 0.25598036 |
| H₂ | 0.60457423 | 0.68240466 |
| CH₄ | 9.0687 · 10⁻⁵ | 0.00010246 |
| CO₂ | 0.04579961 | 0.0516859 |
| N₂ | 0.11947905 | 0.00653811 |
| O₂ | 6.138 · 10⁻¹³ | 6.9151 · 10⁻¹³ |
| Ar | 0.0002808 | 0.00031695 |
| H₂O | 0.0030024 | 0.00297157 |
| NH₃ | 0 | 0 |
| R-value | 2.05000114 | 2.05000953 |
| Conversion of NH₃ in parts | 0.98298886 | — |

### Example 6 and Comparative Example 7: Natural Gas Based ATR Coupled to NH₃ Reforming

For a natural gas based autothermal reforming (ATR) process a feedstock of 10,000 Nm³/h was defined as reference. The ATR process has generally a lower outlet temperature compared to the POx process and the syngas is generally a bit richer in hydrogen (R-value of 1.80). In example 6 NH₃ was fed into the outlet stream, and in comparative example 7 hydrogen was directly added. Since the temperature was lower at the outlet of the ATR (975° C.), at least inert material as contact material for the NH₃ reforming was applied. The temperature decreased through the endothermic NH₃ reforming process from 975 to 884° C. Table 5 shows the compositions of the inlet streams and the need oxygen for the ATR process. Table 6 shows the composition of the created syngas with an R-value of 2.05.

TABLE 5
Natural gas based ATR process with and without NH₃ addition.

| | | Comparative |
|---|---|---|
| | Example 6 | example 7 |
| Feedstock (first precursor | 10000 | 10000 |
| gas stream) [Nm³/h] | | |
| Stream composition in parts | | |
| H₂ | 0.02999997 | 0.02999997 |
| CH₄ | 0.93924906 | 0.93924906 |
| CO₂ | 0.00388 | 0.00388 |
| H₂O | 0 | 0 |
| N₂ | 0.003978 | 0.003978 |
| C₂H₆ | 0.01736398 | 0.01736398 |
| C₃H₈ | 0.003395 | 0.003395 |
| n-C₄H₁₀ | 0.001067 | 0.001067 |
| n-C₅H₁₂ | 0.000485 | 0.000485 |
| n-C₆H₁₄ | 0.000582 | 0.000582 |
| n-C₇H₁₆ | 0 | 0 |
| Oxygen feed (second | 5189.52913 | 5189.52913 |
| precursor gas stream) [Nm³/h] | | |
| [kg/h] | 7412.3961 | 7412.3961 |
| Stream comprising CO and | | |
| H₂ (first gas stream) | | |
| Stream composition in parts | | |
| CO | 0.158494 | 0.158494 |
| H₂ | 0.492278 | 0.492278 |
| CH₄ | 0.032877 | 0.032877 |
| CO₂ | 0.074359 | 0.074359 |
| N₂ | 0.000999 | 0.000999 |
| O₂ | 1.38 · 10⁻¹³ | 1.38 · 10⁻¹³ |
| Ar | 0.000276 | 0.000276 |
| H₂O | 0.240594 | 0.240594 |
| Ammonia feed (second gas | 1495.16226 | 0 |
| stream) [Nm³/h] | | |
| [kg/h] | 1136.04877 | 0 |
| T [° C.] | 300 | 0 |
| H2 feed [Nm³/h] | 0 | 2222.6782 |
| Outlet gasifier | | |
| T [° C.] | 975.00915 | 975.00915 |
| p bar(abs) | 42.01 | 42.01 |
| after NH₃ addition | | |
| T [° C.] | 939.33997 | 975.009151 |
| after NH₃ conversion | | |
| T[° C.] | 884.95261 | 974.94066 |

TABLE 6
Syngas composition after natural
gas based ATR after NH₃ removal

| | | Comparative |
|---|---|---|
| | Example 6 | example 7 |
| Syngas [Nm³/h] | 31598.2122 | 28612.41 |
| Stream composition in parts | | |
| CO | 0.18842009 | 0.20808191 |
| H₂ | 0.6556725 | 0.64638372 |
| CH₄ | 0.03908358 | 0.04316163 |
| CO₂ | 0.08833158 | 0.09754036 |
| N₂ | 0.02467078 | 0.00134258 |
| O₂ | 0 | 0 |
| Ar | 0.00032845 | 0.00036272 |
| H₂O | 0.00301938 | 0.00303287 |
| NH₃ | 0.00047046 | 9.0692 · 10⁻⁵ |
| Syngas after NH₃ | 31583.3465 | 30832.4933 |
| separation [Nm³/h] | | |
| Stream composition in parts | | |
| CO | 0.18850878 | 0.19309905 |
| H₂ | 0.65598112 | 0.6719299 |
| CH₄ | 0.03910198 | 0.04005379 |
| CO₂ | 0.08837315 | 0.090517 |
| N₂ | 0.02468239 | 0.00124591 |
| O₂ | 0 | 0 |
| Ar | 0.00032861 | 0.00033661 |
| H₂O | 0.0030208 | 0.00281449 |
| NH₃ | 0 | 0 |
| R-value | 2.05000001 | 2.05 |
| Conversion of NH₃ in parts | 0.99005744 | — |

### Example 8 and Comparative Example 9: Biogas Based ATR Coupled to NH₃ Reforming

The ATR process of a biogas feedstock with 10,000 Nm³/h feed was defined as reference. The biogas was enriched in CO₂ in comparison to the natural gas. Thus, comparatively more NH₃ had to be fed into the hot outlet of the ATR to reach an R-value of 2.05. Table 7 shows the compositions of the inlet streams and needed oxygen for the ATR process. Table 7 shows the biogas conversion. In example 8 NH₃ was added and in comparative example 9 hydrogen was added directly. Since a comparatively huge amount of NH₃ was added and converted, the outlet temperature was even stronger decreased (from 975° C. to 578° C.). In this case a catalytic material was needed since at temperatures below 700° C., the thermally induced decomposition was not fast enough. Since the hot outlet was coupled with a catalytic material for the NH₃ reforming, basically an adiabatic process step was included. Table 8 shows the final syngas composition of the biogas based ATR process coupled to the NH₃ reforming.

TABLE 7
Biogas based ATR process with and without NH₃ addition

| | | Comparative |
|---|---|---|
| | Example 8 | example 9 |
| Feedstock (first precursor | 10000 | 10000 |
| gas stream) [Nm³/h] | | |
| Stream composition in parts | | |
| H₂ | 0 | 0 |
| CH₄ | 0.69207126 | 0.69207126 |
| CO₂ | 0.28709106 | 0.28709106 |
| H₂O | 0 | 0 |
| N₂ | 0.02083767 | 0.02083767 |
| C₂H₆ | 0 | 0 |
| C₃H₈ | 0 | 0 |
| n-C₄H₁₀ | 0 | 0 |
| n-C₅H₁₂ | 0 | 0 |
| n-C₆H₁₄ | 0 | 0 |
| n-C₇H₁₆ | 0 | 0 |
| Oxygen feed (second | 4220.55732 | 4219.74944 |
| precursor gas stream) | | |
| [Nm³/h] | | |
| [kg/h] | 6028.37787 | 6027.22395 |
| Stream comprising CO and | | |
| H₂ (first gas stream) | | |
| Stream composition in parts | | |
| CO | 0.230541 | 0.230541 |
| H₂ | 0.553554 | 0.553554 |
| CH₄ | 0.016594 | 0.016594 |
| CO₂ | 0.185171 | 0.185171 |
| N₂ | 0.009116 | 0.009116 |
| O₂ | 0 | 0 |
| Ar | 0.000373 | 0.000373 |
| H₂O | 0.004482 | 0.004482 |
| Ammonia feed (second | 7580.61099 | 0 |
| gas stream) [Nm³/h] | | |
| [kg/h] | 5759.87235 | 0 |
| T [° C.] | 300 | 0 |
| H₂ feed [Nm³/h] | 0 | 10953.0573 |
| Outlet gasifier | | |
| T [° C.] | 975.17273 | 974.953019 |
| p bar(abs] | 42.01 | 42.01 |
| after NH₃ addition | | |
| T [° C.] | 815.768828 | 974.953022 |
| after NH₃ conversion | | |
| T[° C.] | 578.011462 | 975.163608 |

TABLE 8
Syngas composition after biogas based ATR after NH₃ removal

| | | Comparative |
|---|---|---|
| | Example 8 | example 9 |
| Syngas [Nm³/h] | 37528.3919 | 33591.4186 |
| Stream composition in parts | | |
| CO | 0.1391347 | 0.15536896 |
| H₂ | 0.62595959 | 0.69912481 |
| CH₄ | 0.00997542 | 0.01118305 |
| CO₂ | 0.11171421 | 0.12479293 |
| N₂ | 0.10283048 | 0.0061434 |
| O₂ | 0 | 0 |
| Ar | 0.00022491 | 0.00025121 |
| H₂O | 0.00303449 | 0.00302036 |
| NH₃ | 0.00712583 | 0.00011487 |
| Syngas after NH₃ | 37260.9712 | 33587.5601 |
| separation [Nm³/h] | | |
| Stream composition in parts | | |
| CO | 0.14013327 | 0.15538681 |
| H₂ | 0.63045208 | 0.69920513 |
| CH₄ | 0.01004702 | 0.01118434 |
| CO₂ | 0.11251598 | 0.12480727 |
| N₂ | 0.10356849 | 0.0061441 |
| O₂ | 0 | 0 |
| Ar | 0.00022653 | 0.00025123 |
| H₂O | 0.00305627 | 0.00302071 |
| NH₃ | 0 | 0 |
| R-value | 2.05002036 | 2.05 |
| Conversion of NH₃ in parts | 0.96472306 | — |

### BRIEF DESCRIPTION OF FIGURES

FIG. 1: shows the activity determined for the case according to Reference Example 1, in particular of the reactor with respect to NH₃ conversion for the case where SiC was used as inert material (measurement points depicted as diamonds). The temperature is noted in ° C. on the abscissa and the NH₃ conversion is noted in % on the ordinate. The dotted line relates to an approximation with an exponential function for the reactor comprising SiC.

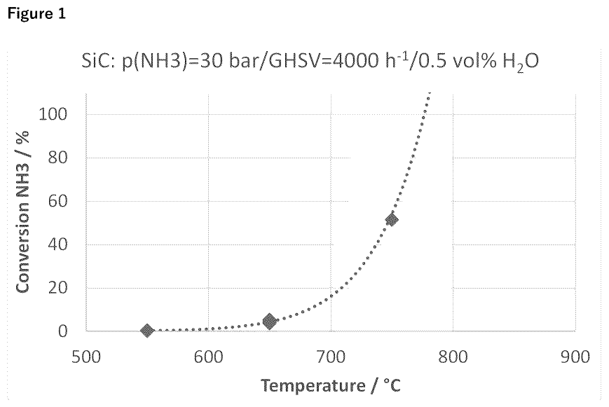

### CITED LITERATURE

WO 2019/038251 A1
U.S. Pat. No. 8,691,182 B2
U.S. Pat. No. 8,961,923 B2

1.-15. (canceled)

16. A process for increasing the H₂ content of a gas stream comprising H₂ and CO (syngas), the process comprising:
(i) providing a first gas stream comprising CO and H₂, and optionally further comprising CO₂, wherein the first gas stream has a temperature in the range of from 750 to 1600° C.;
(ii) providing a second gas stream comprising NH₃; and
(iii) contacting the second gas stream provided in (ii) with the first gas stream provided in (i) for converting at least part of the NH₃ to N₂ and H₂.

17. The process of claim 16, wherein the first gas stream provided in (i) has a molar ratio of H₂ to CO of higher than 0.1:1.

18. The process of claim 16, wherein the first gas stream provided in (i) comprises from 35 to 75 volume-% of H₂.

19. The process of claim 16, wherein the first gas stream provided in (i) comprises from 5 to 45 volume-% of CO.

20. The process of claim 16, wherein the first gas stream provided in (i) comprises CO₂, and wherein the first gas stream provided in (i) comprises from 0.1 to 30 volume-% of CO₂.

21. The process of claim 16, wherein the first gas stream provided in (i) has a stoichiometry number R₁ of lower than 2.00, wherein R₁ is defined according to formula (I):
R₁=[c₁(H₂)−c₁(CO₂)]/[c₁(CO₂)+c₁(CO)] (I),
wherein c₁(H₂), c₁(CO₂), and c₁(CO) stand for the molar concentration of H₂, CO₂, and CO in the first gas stream, respectively.

22. The process of claim 16, wherein the first gas stream provided in (i) comprises a gas stream obtainable or obtained by one or more of a gasification reaction of waste, a gasification reaction of biomass, an autothermal reforming reaction, and a partial oxidation reaction of one or more hydrocarbons, wherein the hydrocarbons are selected from the group consisting of (C₁-C₁₀)alkanes.

23. The process of claim 16, wherein the second gas stream provided in (ii) has a different chemical composition than the first gas stream provided in (i).

24. The process of claim 16, wherein contacting in (iii) is conducted in a reactor.

25. The process of claim 24, wherein contacting in (iii) is conducted in a reactor, and wherein the reactor comprises an inert material.

26. The process of claim 24, wherein contacting in (iii) is conducted in a reactor, and wherein the reactor comprises a catalytic material.

27. The process of claim 26, wherein the catalytic material comprises a metal M1, wherein M1 is Ni, Co, or Ni and Co.

28. The process of claim 16, wherein the process further comprises:
(iv) separating residual NH₃ from the gas stream obtained in (iii), for obtaining a purified gas stream.

29. A process for the preparation of an alcohol, employing a gas stream comprising H₂ and CO, and optionally further comprising CO₂, wherein the gas stream is obtained according to claim 16, wherein the process comprises:
(v) using the gas stream obtained in (iii) or the purified gas stream obtained in (iv) as the feed stream.

30. A process for the preparation of a hydrocarbon or an ether, employing a gas stream comprising H₂ and CO, and optionally further comprising CO₂, wherein the gas stream is obtained according to claim 16, wherein the process comprises:
(v) using the gas stream obtained in (iii) or the purified gas stream obtained in (iv) as the feed stream.
